(19) United States
(12) Patent Application Publication
(10) Pub. No.: US 2010/0149559 A1
(43) Pub. Date: Jun. 17, 2010

(54) SPECIALTY MEDIA CALIBRATION ENHANCEMENT METHOD AND SYSTEM

(75) Inventors: Javier A. Morales, Rochester, NY (US); Michael E. Farrell, Webster, NY (US)

Correspondence Address: ORTIZ & LOPEZ. PLLC, P.O. Box 4484, Albuquerque, NM, 87196-4484, US

(73) Assignee: Xerox Corporation.

(21) Appl. No.: 12/334,603

(22) Filed: Dec. 15, 2008

(51) Int. Cl. H04N 1/60

(52) U.S. Cl. 358/1.9

(57) ABSTRACT

A system and method for enhancing media calibration and rendering to enable the use of multiple sets of calibration curves and intrapage when rendering to a multi-substrate media. A calibration target related to a specific multi-substrate media can be rendered. A number of calibration patches can then be measured with respect to each substrate region on the media. The calibration patches can be utilized to create a custom rendering profile for the multi-substrate media. A rendering job can be processed and a matching custom rendering profile defined in the multi-substrate calibration can then be applied to regions specified in the media definition.

### TECHNICAL FIELD

Embodiments are generally related to image processing methods and systems. Embodiments are also related to color image/text rendering and calibration systems and techniques. Embodiments are additionally related to the provision of specialty media calibration enhancements.

### BACKGROUND OF THE INVENTION

Image-rendering devices such as, for example, monitors, scanners, and printers, often impose distortions on the color characteristics of a rendered image. Hence, matching of color appearance between images and documents transferred among any combination of the digital image rendering devices requires the use of specialized color image processing knowledge regarding the color rendering characteristics associated with different imaging devices. A color management system (CMS) is sometimes necessary because different imaging devices have different color capabilities, describe color characteristics in varying terms, and operate among variable color spaces.

ICC (International Color Consortium) profiles are a professional color management solution and follow an international and accepted standard to enable accurate rendered color for all colors that the rendering devices are capable of reproducing. Calibration techniques can be utilized to create custom profiles (e.g. ICC profile) for various input/output devices by developing a description indicative of how a particular device responds to a color. In general, computers and other electronic equipment generating and inputting color images or documents typically generate three-dimensional or RGB (red, green, blue) color signals. Electrographic devices, such as rendering devices, copiers, and the like, however, often render in four-dimensional or CMYK (cyan, magenta, yellow, and black) colors (and often can also receive such signals as input). A calibration “look-up” table may be utilized to convert each digital RGB color signal value into a corresponding digital CMYK value before or after being received by the rendering device. Due to the nature of rendering inks and their light absorption characteristics, however, complex non-linear calorimetric relationships may exist between the input and output values.

A color calibration look-up table may be utilized to approximate the mapping between RGB colorimetric space and CMYK values. Such a color calibration look-up table can be configured by sending a set of CMYK digital values to the rendering device, measuring the calorimetric RGB values of the resulting color patches outputted by the rendering device, and generating the look-up table from the difference between the input values and the measured output values. More specifically, the color calibration look-up table corrects for non-linearities, rendering parameter variations, and unwanted absorptions of inks, so that the rendering device can render the true corresponding color.

The color patches can be typically measured with a high accuracy spectrophotometer, or the like. When performing calibration, the majority of DFE (Digital Front End) components are capable of targeting results to a specific media definition in order to ensure better image quality when rendering via specific media. The majority of prior art calibration techniques, however, fall short with respect to media that contains multiple substrates such as, for example, so-called DocuCards, DocuMagnets™, EverFlat™ and other specialty media. The substrate can influence the color characteristics of the final printout or rendering in several ways. For example, certain substrate properties such as surface roughness can affect mechanical interactions between colorants and a substrate, which in turn affect the resulting color. Since the rendering device response may vary considerably with respect to different printing substrates, a rendering device characterization is specific to the substrate. Also, such prior art approaches do not allow for ameliorated visible color shifts when rendering on premium, multi-substrate and other specialty media.

Based on the foregoing, it is believed that a need exists for an improved method and system for enhancing media calibration and rendering utilizing multiple sets of calibration curves when rendering to multi-substrate media, as described herein. A need also exists for an improved method and/or system for generating media specific calibration targets.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for an improved image processing method, system and computer-usable medium.

It is another aspect of the present invention to provide for an improved method and system for providing specialty media calibration enhancements for rendering devices, such as printers, scanners, multi-function devices, photocopy machines, and the like.

It is a further aspect of the present invention to provide for an improved method and system for generating media specific calibration targets.

The aforementioned aspects and other objectives and advantages can now be achieved as described herein. A system and method for enhancing media calibration and rendering to enable the use of multiple sets of calibration curves and in intrapage regions when rendering to a multi-substrate media (e.g., DocuCards, Xerox EverFlat media, etc.) is disclosed. Such an approach utilizes multiple look-up tables (LUT) and/or ICC output profile for multiple intrasheet regions in a single media. The multiple look-up tables and/or remote custom ICC output profile can be implemented via the system and methodology described herein. Note that as utilized herein, the acronym ICC generally refers to “International Color Consortium”, an industry consortium, which has defined an open standard for a color-matching module (CMM) at the OS level and color profiles for the devices and working space.

A media type loaded in a calibration system can be specified and a calibration target related to the specified media can be rendered if the media is a multi-substrate media. The sheet regions that utilize a different substrate can be placed on a spectrophotometer and instructions related to the media can be sent to the spectrophotometer in order to measure a number of calibration patches for each substrate region on the media. The calibration patches can be utilized to create a region-specific LUT for the multi-substrate media. A rendering job can be processed by a raster image processor (RIP) and portions of a page can be selected based on the regions specified in a media definition.

The media definition can be configured to include data indicative of descriptions of multiple intra sheet regions that utilize a different substrate and/or a substrate combination. The matching LUT defined in the multi-substrate calibration can then be applied to each of the regions. Such an approach utilizes separate substrate-specific calibration curves in different regions depending on the substrate type. Optionally, the RIP can apply transition functions at the boundary between two regions of different calibration to minimize visible artifacts of the change. Such an approach disclosed herein ameliorates some of the very visible color shifts that occur when rendering on premium, multi-substrate specialty media.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a block diagram of a calibration system, which can be implemented in accordance with a preferred embodiment;

FIG. 2 illustrates a schematic diagram of a calibration system that is capable of providing specialty media calibration enhancements for a rendering device, in accordance with a preferred embodiment; and

FIG. 3 illustrates a high level flow chart depicting logical operational steps of a method for enhancing media calibration and rendering to enable the use of multiple sets of calibration curves when rendering to a multi-substrate media, in accordance with a preferred embodiment.

### DETAILED DESCRIPTION

The particular values and configurations discussed in these non-limiting examples can be varied and are cited merely to illustrate at least one embodiment and are not intended to limit the scope thereof.

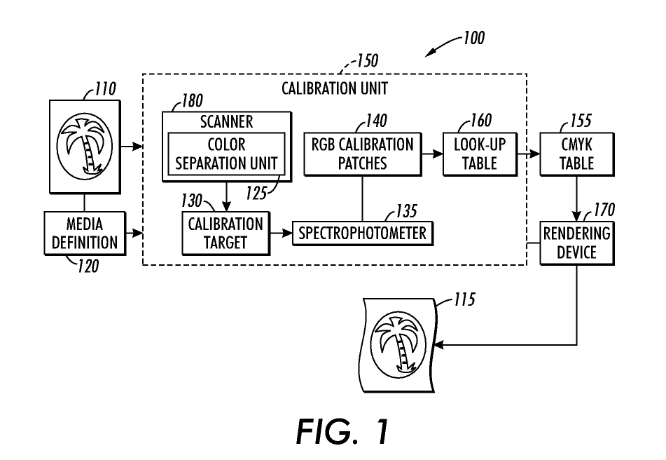

FIG. 1 illustrates a block diagram of a calibration system 100 associated with a rendering device 170, which can be implemented in accordance with a preferred embodiment. Calibration system 100 can be configured to control the rendering and color calibration of the rendering device 170. Calibration system 100 can be operatively coupled to a scanner 180 and the rendering device 170. Note that as utilized herein, the term “rendering device” may refer to an apparatus or system such as a printer, scanner, fax machine, copy machine, etc., and/or a combination thereof. In this sense, scanner 180 and rendering device 170 may provide certain functions (e.g., scanning) that overlap with one another. In some embodiments, rendering device 170 may be implemented with a single rendering function such as printing. In other embodiments, rendering device 170 can be configured to provide multiple rendering functions, such as scanning, faxing, printing and copying.

Calibration system 100 is capable of calibrating the rendering device 170 by measuring, for each color plane, the rendered colorant densities specific to the rendering device 170, and then adjusting characterization profile set in accordance with measured colorant densities to generate an ICC output profile such as a look-up table 160. The multiple look-up tables or remote custom ICC output profile can be implemented via the system and methodology described herein. The ICC created a standardized system for describing the color-rendering capabilities of any device such as the rendering device 170. The look-up table 160 can be utilized during the rendering process to adjust (calibrate) each colorant plane (C, M, Y and K) of the image data just prior to rendering.

The calibration system 100 generally includes a calibration unit 150 that comprises a color separation unit 125 and a spectrophotometer 135 for generating the look-up table 160. A rendering job comprising an image 110 in association with rendering media definitions 120 for rendering images thereon can be scanned by the scanner 180 associated with the color separation unit 125 to produce a set of digital calorimetric or device independent data describing the original image 110, rendered in, for example, RGB values and/or in device independent spaces such as L*a*b* and XYZ. Note that the media for rendering images thereon can be a multi-substrate media that contains multiple substrates.

Note that spectrophotometer 135 is a device that is capable of performing spectroscopy and/or related applications. Spectroscopy is the measurement and analysis of electromagnetic radiation absorbed, scattered, or emitted by atoms, molecules, or other chemical or physical materials. Each object affects light in its own unique way. When light waves strike an object, the object's surface absorbs some of the spectrum's energy, while other parts of the spectrum are reflected back from the object. The modified light that is reflected from the object has an entirely new composition of wavelengths. Different surfaces containing various pigments, dyes, and inks (or chemistry/materials) generate different but unique wavelength compositions. Light can be modified by striking a reflective object such as paper; or by passing through a transmissive object such as film or a transparency. The pattern of wavelengths that leaves an object is the object's spectral data, which is often called the “finger print” of the object. Measuring spectral content of the object can give its intrinsic properties. For example, the region of the electromagnetic spectrum visible to the human eye ranges from about 400 nm to 700 nm, and if spectral measurements can be made in that wavelength range, then one can determine “the color of the object”. The amount of reflectance intensity decomposed at each wavelength is the most complete and infallible description of the color one can see. Hence in this case, the spectrophotometer becomes a true color sensor. If the UV-Vis spectrum (Ultraviolet and visible spectrum) is from 200 nm to 800 nm, then the UV-V spectrum could be used to identify the material composition—which is a form of non-contact, non-reactive chemical test—which can be used to analyze the compounds.

Spectrophotometers with a broad range of spectral synthesis have a wide range of application, including color printing, color measurements in displays, paints, textiles, electronic cameras, chemical analysis, environmental monitoring, measurement of bio-samples for medicine or personal identification, etc. All commercial spectrophotometers tend to be large in size with many optical elements.

Note that various types of spectrophotometer devices may be utilized to implement spectrophotometer 135. For example, one type of spectrophotometer that may be employed to implement spectrophotometer 135 is disclosed in U.S. Pat. No. 7,333,208, entitled “Full width array mechanically tunable spectrophotometer,” which issued to Lalit K. Mestha, et al. on Feb. 19, 2008. Another spectrophotometer that can be configured as spectrophotometer 135 is disclosed in U.S. Pat. No. 7,307,720, entitled “Method for corrected spectrophotometer output for measurements on multiple substrates,” which issued to Lalit K. Mestha, et al. on Dec. 11, 2007. U.S. Pat. No. 7,307,720 is incorporated herein by reference in its entirety and is assigned to the Xerox Corporation. Another example of a spectrophotometer, which may be utilized to implement spectrophotometer 135 is disclosed in U.S. Pat. No. 7,110,142, entitled “Systems and methods for sensing marking substrate area coverage using a spectrophotometer,” which issued to Lalit K. Mestha, et al. on Sep. 19, 2006 and is incorporated herein by reference in its entirety and is also assigned to the Xerox Corporation. Note that such spectrophotometers are not considered limiting features of the present invention, but are discussed herein for general illustrative and edification purposes only.

The media definition 120 includes descriptions of the sheet regions of the media that utilize a different substrate or substrate combination. For example, DocuCards can specify two regions, one covering the plastic card itself and another covering the remainder of the sheet. Xerox EverFlat media can specify three regions; one covering the polyester hinge, one covering the polyester and paper regions (where color shifts are most objectionable) and one covering the paper region of the sheet. The media definition 120 can be loaded to the calibration unit 150. The calibration unit 150 can be further utilized to render a calibration target 130 with respect to the media definition 120.

The calibration unit 150 converts the device independent data to device dependent data. The calibration can be performed by rendering the calibration target 130 and the media-specific instructions that are electronically communicated/transmitted to a spectrophotometer 135 in order to measure RGB calibration patches 140 and comparing those measurements with a set of expected measurements and correcting for the difference between the two sets. Note that calibration can be performed automatically (e.g. controlling the position of the spectrophotometer sensing device) or manually, depending upon design goals and considerations. The spectrophotometer 135 measures the spectrum of energy reflected across the range of visible wavelengths. The spectrophotometer 135 produces light of any selected color (wavelength) (RGB) from the color separation unit 125 and the intensity of the light can be measured. The spectrophotometer 135 also measures RGB calibration patches 140 for each substrate region on the media utilizing the colors generated by the color separation unit 135 for each calibration target 130. The measured colors of these patches 140 can be utilized to build a three dimensional look-up table 160 relating RGB defined colors to CMYK defined colors. Note that both the RGB and the CMYK are related to a Profile Connection Space (PCS) with as L*a*b*. When one converts from one color to another, a conversion actually occurs from RGB to L*a*b* and then from L*a*b* to CMYK.

Color signals RGB can be processed to generate address entries to the look-up table 160 therein which stores a set of transform coefficients with which the signals RGB can be processed to convert them to CMYK colorant signals 155 or any multi-dimensional output color space including, but not limited to, CMYK or spectral data. The output of the calibration unit 150 is the image defined in terms of device dependent space CMYK values 155 that can be utilized to drive the rendering device 170. The colorant signals represent the relative amounts of cyan, magenta, yellow, and black toners to be deposited over a given area in the rendering device 170. The rendered output image on the multi-substrate media 115 may be defined in terms of RGB, such that the rendered output image possesses a color that is calorimetrically similar to the original image 110, although that similarity is ultimately dependent upon the gamut of the rendering device 170.

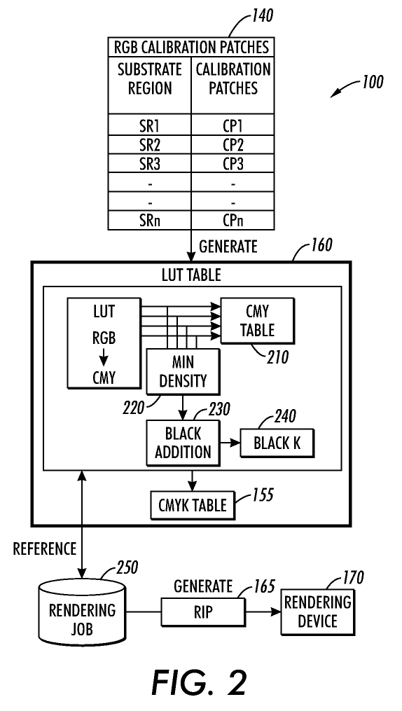

FIG. 2 illustrates a schematic diagram of the calibration system 100 providing specialty media calibration enhancements for the rendering device 170, which can be implemented in accordance with a preferred embodiment. Note that in FIGS. 1-3, identical or similar blocks are generally indicated by identical reference numerals. The spectrophotometer 135 measures the calibration patches 140 (e.g., CP1, CP2 . . . CPn) for each substrate regions (e.g., SR1, SR2 . . . SRn) based on media-specific instructions, as shown in FIG. 2. This can be done by rendering and measuring about 1000 to 4000 patches of rendering device colors distributed throughout the color space, i.e., a large set of rendering device driving signals are generated, in varying densities of combinations of CMYK or other rendering device colors and utilized to drive the rendering device 170. The color of each patch CP1, CP2 . . . CPn can be measured utilizing the spectrophotometer 135 to determine color in terms of RGB.

The measured colors of these patches CP1, CP2. CPn can be utilized to build the multidimensional look-up table 160 relating RGB defined colors to CMY defined colors in order to generate CMY tables 210. In general, cyan, magenta, and yellow inks, or colorants, cannot produce a high quality black image when combined. To enhance the shadow details of rendered images in the media, and to save non-black colorants, a fourth color, black (K) 240 can be added utilizing black addition 230. The amount of black ink is zero until some minimum density 220 and then increases quadratically as a function of requested density. The addition of black ink 240 is primarily an aesthetic determination.

The CMYK table 155 can be utilized as a reference to a rendering job 250. The rendering job 250 can be processed through a raster image processor (RIP) 165 and the portions of the media that are to be rendered can be selected based on the regions specified in the media definition 120. For each region of the media, the calibration system 100 can apply the defined matching look-up table 160. The calibration system 100 can enable the use of multiple sets of calibration curves, intrapage, when rendering the rendering job 250 on the multi-substrate media 115. Optionally, the RIP 165 can be utilized to apply transition functions at the boundary between two regions of the media to minimize visible artifacts of the change. For example, the RIP 165 can average the CMYK values utilizing both the calibration patches 140 and the look-up table 160 to apply a transition zone in the media. Note that the embodiments discussed herein should not be construed in any limited sense. It can be appreciated that such embodiments reveal details for a better understanding of the invention and may be subject to change by skilled persons within the scope of the invention without departing from the concept thereof.

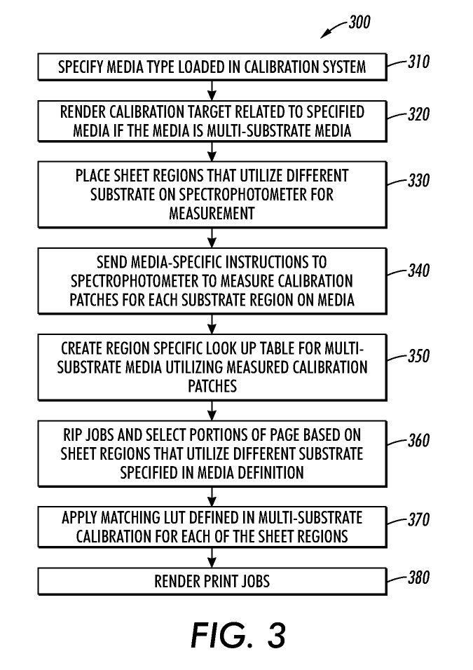

FIG. 3 illustrates a high level flow chart illustrating logical operational steps of a method 300 for enhancing media calibration and rendering to enable the use of multiple sets of calibration curves and intrapage regions when rendering to a multi-substrate media, which can be implemented in accordance with a preferred embodiment. Again as a reminder, in FIGS. 1-3 identical or similar blocks are generally indicated by identical reference numerals. The type of the media that is loaded in the calibration system 100 for rendering images thereon can be specified, as depicted at block 310. The calibration target 130 related to specific media selection can be rendered if the media is a multi-substrate media, as depicted at block 320. The sheet regions that utilize different substrate can be placed on the spectrophotometer 135 for measurements, as illustrated at block 330.

Thereafter, the media specific instructions can be sent to the spectrophotometer 135 to measure RGB calibration patches 140 for each substrate region in the multi-substrate media 115, as illustrated at block 340. In the case of Xerox Everflat media, the spectrophotometer can scan a nominal set of patches from the main part of the media, a set of patches for the portions of the media covered in polyester and a set of patches for the portions of the media that possess polyester but no paper. The region specific look-up table 160 for the multi substrate media 115 can be created utilizing measured calibration patches, as depicted at block 350. The rendering job 250 can then be processed utilizing the RIP 165 and portions of page based on sheet regions that utilize different substrate specified in the media definition 120, as depicted at block 360.

The matching look-up table defined in multi-substrate calibration can be applied for each of the sheet regions, as shown at block 370. Further, the rendering job 250 can be rendered on the media 115 utilizing the rendering device 170, as depicted at block 380. The calibration system 100 can provide effective calibration and rendering functions with multiple look-up tables 160 or ICC output profile for multiple intrasheet regions in a single media. Thus, the system 100 can be effectively utilized to ensure better image quality when rendering on specific media that contains multiple substrates such as for example, Xerox DocuCards, DocuMagnets™, EverFlat™ and other specialty media. Such an approach ameliorates some of the very visible color shifts that happen when rendering on premium, multi-substrate specialty media.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for providing specialty media calibration enhancements, said method comprising:
rendering a calibration target related to a multi-substrate specialty media;
measuring a plurality of calibration patches for each substrate region on said multi-substrate specialty media, wherein each patch measurement value thereof is uniquely associated with a specific substrate region; and
creating a custom rendering profile utilizing said plurality of calibration patches for said multi-substrate specialty media in order to thereafter apply a matching custom rendering profile to a plurality of intrasheet regions specified in a media definition with respect to a rendering job, thereby enhancing media calibration when rendering said rendering job to said multi-substrate specialty media.

2. The method of claim 1 further comprising electronically communicating instructions related to said multi-substrate to a spectrophotometer in order to measure said plurality of calibration patches.

3. The method of claim 1 further comprising configuring said custom rendering profile with respect to a specific type of media.

4. The method of claim 1 wherein said media definition includes descriptive data related to said plurality of intrasheet regions that utilize a different substrate.

5. The method of claim 1 further comprising configuring said media definition to include descriptive data related to said plurality of intrasheet regions that utilize a substrate combination.

6. The method of claim 1 wherein applying said matching custom rendering profile to said plurality of intrasheet regions, further comprises:
processing said rendering job utilizing a raster image processor; and
selecting portions of a page based on said plurality of intrasheet regions that utilize said different substrate specified in said media definition.

7. The method of claim 1 wherein said custom rendering profile comprises a region-specific look-up table.

8. The method of claim 1 wherein said custom rendering profile comprises an ICC profile format.

9. The method of claim 1 further comprising applying a transition function at a boundary between at least two regions of different calibration to minimize visible artifacts.

10. The method of claim 1 further comprising configuring media-specific calibration targets to ameliorate visible color shifts that occur when rendering on said multi-substrate specialty media.

11. A method for providing specialty media calibration enhancements, said method comprising:
rendering a calibration target related to a multi-substrate specialty media;
measuring a plurality of calibration patches for each substrate region on said multi-substrate specialty media, wherein each patch measurement value thereof is uniquely associated with a specific substrate region;
creating a custom rendering profile utilizing said plurality of calibration patches for said multi-substrate specialty media in order to thereafter apply a matching custom rendering profile to a plurality of intrasheet regions specified in a media definition with respect to a rendering job; and
configuring said custom rendering profile with respect to a specific type of media, thereby enhancing media calibration when rendering said rendering job to said multi-substrate specialty media.

12. A system for providing specialty media calibration enhancements, said system comprising:
a processor;
a data bus coupled to the processor; and
a computer-usable medium embodying computer code, the computer-usable medium being coupled to the data bus, the computer program code comprising instructions executable by the processor and configured for:
rendering a calibration target related to a multi-substrate specialty media;
measuring a plurality of calibration patches for each substrate region on said multi-substrate specialty media, wherein each patch measurement value thereof is uniquely associated with a specific substrate region; and
creating a custom rendering profile utilizing said plurality of calibration patches for said multi-substrate specialty media in order to thereafter apply a matching custom rendering profile to a plurality of intrasheet regions specified in a media definition with respect to a rendering job, thereby enhancing media calibration when rendering said rendering job to said multi-substrate specialty media.

13. The system of claim 12 further comprising electrical communications for electronically communicating instructions related to said multi-substrate to a spectrophotometer in order to measure said plurality of calibration patches.

14. The system of claim 12 wherein said instructions are further configured for creating said custom rendering profile with respect to a specific type of media.

15. The system of claim 12 wherein said media definition includes descriptive data related to said plurality of intrasheet regions that utilize a different substrate.

16. The system of claim 12 wherein said instructions are further configured for modifying said media definition to include descriptive data related to said plurality of intrasheet regions that utilize a substrate combination.

17. The system of claim 12 wherein applying said matching custom rendering profile to said plurality of intrasheet regions, further comprises:
processing said rendering job utilizing a raster image processor; and
selecting portions of a page based on said plurality of intrasheet regions that utilize said different substrate specified in said media definition.

18. The system of claim 12 wherein said custom rendering profile comprises a region-specific look-up table.

19. The system of claim 12 wherein said instructions are further configured for applying a transition function at a boundary between at least two regions of different calibration to minimize visible artifacts.

20. The system of claim 12 wherein said instructions are further configured for modifying said media-specific calibration targets to ameliorate visible color shifts that occur when rendering on said multi-substrate specialty media.
